(19) United States
(12) Patent Application Publication
(10) Pub. No.: US 2018/0260496 A1
(43) Pub. Date: Sep. 13, 2018

(54) JIG DESIGN ASSISTING DEVICE AND ROBOT SIMULATION DEVICE

(71) Applicant: FANUC CORPORATION, Yamanashi (JP)

(72) Inventor: Kouzou Inoue, Yamanashi (JP)

(73) Assignee: FANUC CORPORATION, Yamanashi (JP)

(21) Appl. No.: 15/900,852

(22) Filed: Feb. 21, 2018

(30) Foreign Application Priority Data
Mar. 9, 2017 (JP) 2017-045186

(51) Int. Cl. G06F 17/50; B23Q 3/00

(52) U.S. Cl. CPC G06F 17/50; G06F 17/5009; G06T 19/20; G06F 2217/02; B23Q 3/00

(57) ABSTRACT

A jig design assisting device and a robot simulation device that can create a rough virtual model of a jig through a simple operation and assist a designer. The assisting device includes: a display section; a storage section that stores three-dimensional models of a workpiece and a jig; a workpiece designating section that designates the type of the workpiece; a workpiece locating section that automatically locates the designated workpiece in a three-dimensional space; a block selecting section that selects the type and location method of the positioning block; a clamper selecting section that selects the type of the clamper; a model part designating section that designates a part of the workpiece model; a jig locating section that locates the positioning block or the clamper within a three-dimensional space; and an adjusting section that automatically adjusts the dimension or shape of the three-dimensional model of the positioning block or the clamper.

### BACKGROUND OF THE INVENTION

### 1. Field of the Invention

The present invention relates to a jig design assisting device and a robot simulation device.

### 2. Description of the Related Art

In machining processes carried out by machine tools, etc., a jig may be used to anchor an object to be processed (a workpiece) at a predetermined position. With recent advances in CAD/CAM techniques, such jigs are increasingly being designed through CAD. For example, JP 2779180 B discloses the following: “As described thus far, the present invention is an automatic design device for a jig used when working on a workpiece, the device comprising: means for sequentially generating structure models of components constituting the jig, using data pertaining to a worked part of a workpiece being worked on as a departure point; means for storing a database of standard components corresponding to the individual components constituting the jig; and means for determining the standard component corresponding to each component by searching the database on the basis of the structure models of the components”.

CAD techniques for relocating a jig so as not to interfere with a workpiece, techniques for automatically designing a clamp jig on the basis of shape data of a standard clamp jig, and the like are also known (e.g. JP H08-050601 A and JP S63-119987 A).

Thus far, only a designer with extensive experience using CAD, etc., has had the knowledge to design a jig that anchors a workpiece in a machine tool, etc., in terms of determining the sizes and locations of a positioning block and a clamper that constitute the jig. Thus, what is needed is a technique for assisting a designer to be able to create a rough virtual model of a jig through simple operations.

### SUMMARY OF THE INVENTION

One aspect of the present disclosure is a jig design assisting device configured to assist designing of a jig, the jig including a positioning block and a clamper, and the jig anchoring a workpiece, the device including: a display section configured to display a virtual three-dimensional space on a screen; a storage section configured to store three-dimensional models of the workpiece, the positioning block, the clamper, and an attachment plate to which the workpiece can be attached; a workpiece designating section configured to designate a type of the workpiece anchored by the jig; a workpiece locating section configured to read out the three-dimensional model of the workpiece designated by the workpiece designating section from the storage section, read out the three-dimensional model of the attachment plate to which the designated workpiece can be attached from the storage section, and automatically locate the designated workpiece within the three-dimensional space in a state in which the workpiece is attached to the read-out attachment plate; a positioning block selecting section configured to select a type and a location method of the positioning block; a clamper selecting section configured to select a type of the clamper; a model part designating section configured to designate a model part, in the three-dimensional model of the designated workpiece, that contacts the positioning block or the clamper; a jig locating section configured to read out the three-dimensional model of the positioning block or the clamper from the storage section and locate the read-out three-dimensional model in the three-dimensional space, based on the designated model part and the content of the selection made by the positioning block selecting section or the clamper selecting section; and an adjusting section configured to automatically adjust a dimension or a shape of the three-dimensional model of the positioning block or the clamper located by the jig locating section, in accordance with a dimension or a shape of the designated workpiece.

Another aspect of the present disclosure is a robot simulation device configured to locate a three-dimensional model of a jig, the jig being designed or created by the above-described jig design assisting device, in a virtual space in which a virtual three-dimensional model of a robot is located, and simulate an operation of the robot.

### BRIEF DESCRIPTION OF THE DRAWINGS

The objects, features and advantages of the invention will become more apparent from the following description of the embodiments in connection with the accompanying drawings, wherein:

FIG. 1 is a diagram illustrating an example of the configuration of a jig design assisting device according to an embodiment;

FIG. 2 is a flowchart illustrating an example of processing carried out by the jig design assisting device of FIG. 1;

FIG. 3 is a diagram illustrating an example of a screen display made when designating the type of a workpiece;

FIG. 4 is a diagram illustrating an example of a workpiece and a plate to which the workpiece is to be attached being automatically located in a virtual space;

FIG. 5 is a diagram illustrating an example of a screen display when selecting the type of a positioning block;

FIG. 6 is a diagram illustrating an example of a screen display when selecting a method for locating a positioning block;

FIG. 7a is a diagram illustrating an example of a screen display when designating a location place of a positioning block;

FIG. 7b is a diagram illustrating an example of a screen display in a state where a positioning block has been located in a designated place;

FIG. 7c is a diagram illustrating an example of a screen display in a state where a plurality of positioning blocks have been located;

FIG. 8a is a diagram illustrating an example of automatically adjusting the height of a positioning block located on a side face of a workpiece;

FIG. 8b is a diagram illustrating an example of automatically adjusting the height of a positioning block located on a bottom face of a workpiece;

FIG. 9a is a diagram illustrating an example of automatically adjusting the height of a V-shaped block located on a side surface of a cylindrical workpiece;

FIG. 9b is a diagram illustrating an example of automatically adjusting the height of an L-shaped block located on a side face of a parallelepiped workpiece;

FIG. 10 is a diagram illustrating an example of a screen display in a state where a pin block is located within a hole in a cylindrical workpiece;

FIG. 11 is a diagram illustrating an example of a screen display when selecting the type of a clamper;

FIG. 12a is a diagram illustrating an example of a screen display when selecting a location place of a clamper;

FIG. 12b is a diagram illustrating an example of a screen display in a state where a clamper has been located in a designated place;

FIG. 13 is a diagram illustrating an example of a screen display when making definitions/settings pertaining to the movement of a mobile part of a clamper;

FIG. 14a is a diagram illustrating an example of a screen display in a case where a jig designed/created by the jig design assisting device of FIG. 1 is applied in a robot simulator, and illustrates a state in which a clamper is closed; and

FIG. 14b is a diagram illustrating a state in which the clamper has opened from the state of FIG. 14a.

### DETAILED DESCRIPTION

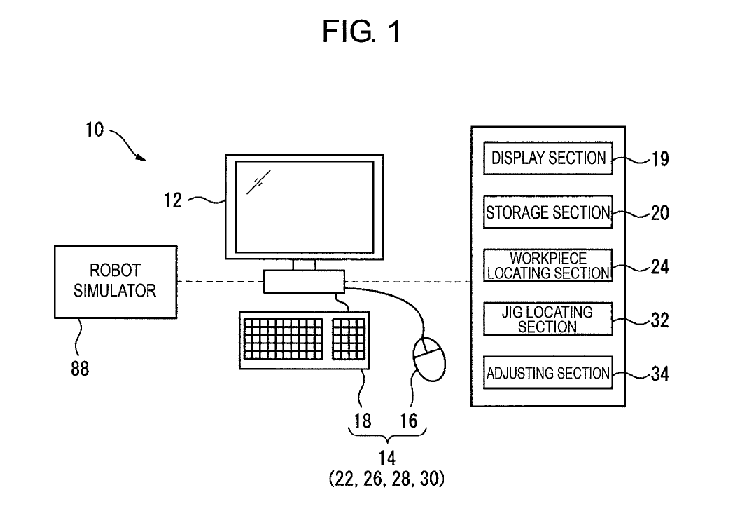

FIG. 1 is a diagram illustrating an example of the configuration of a jig design assisting device (also called simply an “assisting device” hereinafter) according to a preferred embodiment of the present disclosure. The assisting device is a device that assists a designer with the detailed design of a jig for anchoring or fixing a workpiece to be processed by a machine tool (not illustrated), etc., in a predetermined position, by creating a rough three-dimensional model of the jig before the jig is designed in detail. More specifically, the device creates a rough model of the jig in order to examine interference between components constituting the jig (a positioning block and a clamper, etc., which will be described later), interference between the jig and a robot hand that carries out work such as gripping the workpiece, etc.

An assisting device 10 can be provided as a device including an arithmetic processing device (or a processor) and a storage device (or a memory), e.g., a personal computer, and includes a display 12, which displays a three-dimensional image (a virtual three-dimensional space; described later), and an input section 14, which accepts input operations from a designer (or an operator). Although a mouse 16, a keyboard 18, and a touch panel (not illustrated), etc., of the personal computer can be used as the input section 14, the display 12 may be equipped with touch panel functionality for accepting touch inputs from the designer.

The assisting device 10 includes: a display (processing) section 19 that carries out a process for displaying a virtual three-dimensional space on the display 12; a storage section 20 that stores three-dimensional models of a workpiece, a positioning block, a clamper, and an attachment plate to which the workpiece can be attached; a workpiece designating section 22 that accepts an input for designating the type of a workpiece to be anchored by a jig; a workpiece locating section 24 that reads out a CAD model of the workpiece designated by the workpiece designating section 22 from the storage section 20, reads out a three-dimensional model of an attachment plate to which the designated workpiece can be attached from the storage section 20, and automatically locates the designated workpiece within a three-dimensional space in a state where the workpiece is attached to the read-out attachment plate; a positioning block selecting section 26 that accepts an input for selecting the type and location method of a positioning block; a clamper selecting section 28 that accepts an input for selecting the type of a clamper; a model part designating section 30 that accepts an input for designating a model part (or a model surface), in the three-dimensional model of the designated workpiece, that contacts the positioning block or the clamper; a jig locating section 32 that, on the basis of the designated model part and the content of the selection made by the positioning block selecting section 26 or the clamper selecting section 28, reads out the three-dimensional model of the positioning block or the three-dimensional model of the clamper from the storage section 20 and locates that model in the three-dimensional space; and an adjusting section 34 that, in accordance with the dimension or the shape of the designated workpiece, automatically adjusts the dimension or the shape of the three-dimensional model of the positioning block or the three-dimensional model of the clamper located by the jig locating section 32.

In the present embodiment, the above-described storage device (memory) handles the function of the storage section 20, the above-described input section (mouse 16, keyboard 18, and the touch panel, etc.) handles the functions of the workpiece designating section 22, the positioning block selecting section 26, the clamper selecting section 28, and the model part designating section 30, and the above-described arithmetic processing device (processor) handles the functions of the display section 19, the workpiece locating section 24, the jig locating section 32, and the adjusting section 34; however, this is only one example. Additionally, the storage device (storage section 20) can be configured as a device separate from the personal computer and the like constituting the assisting device 10 to improve the appearance, and such a configuration is also assumed to be included in the present disclosure.

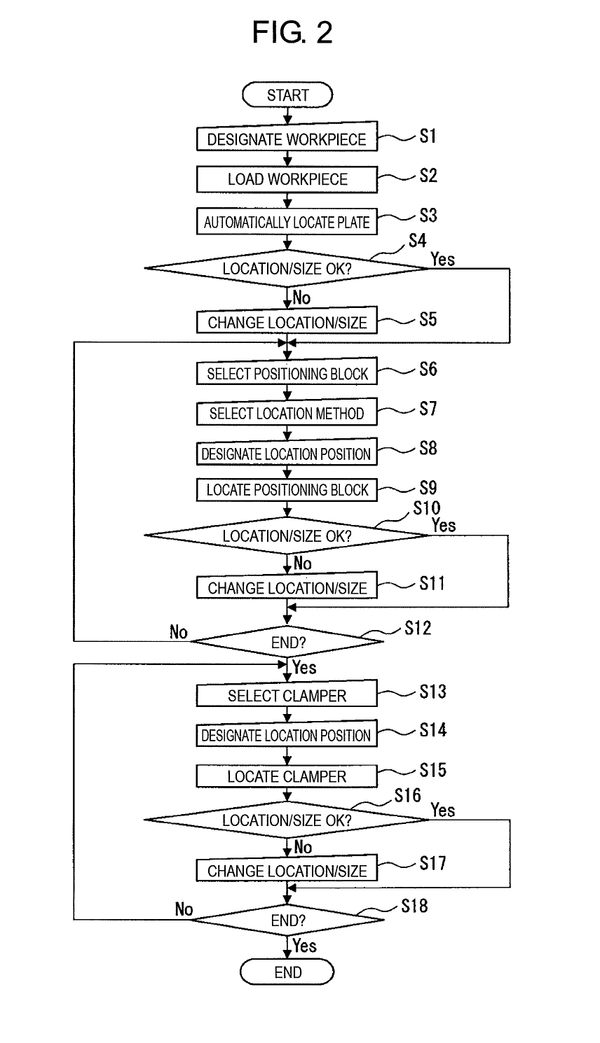

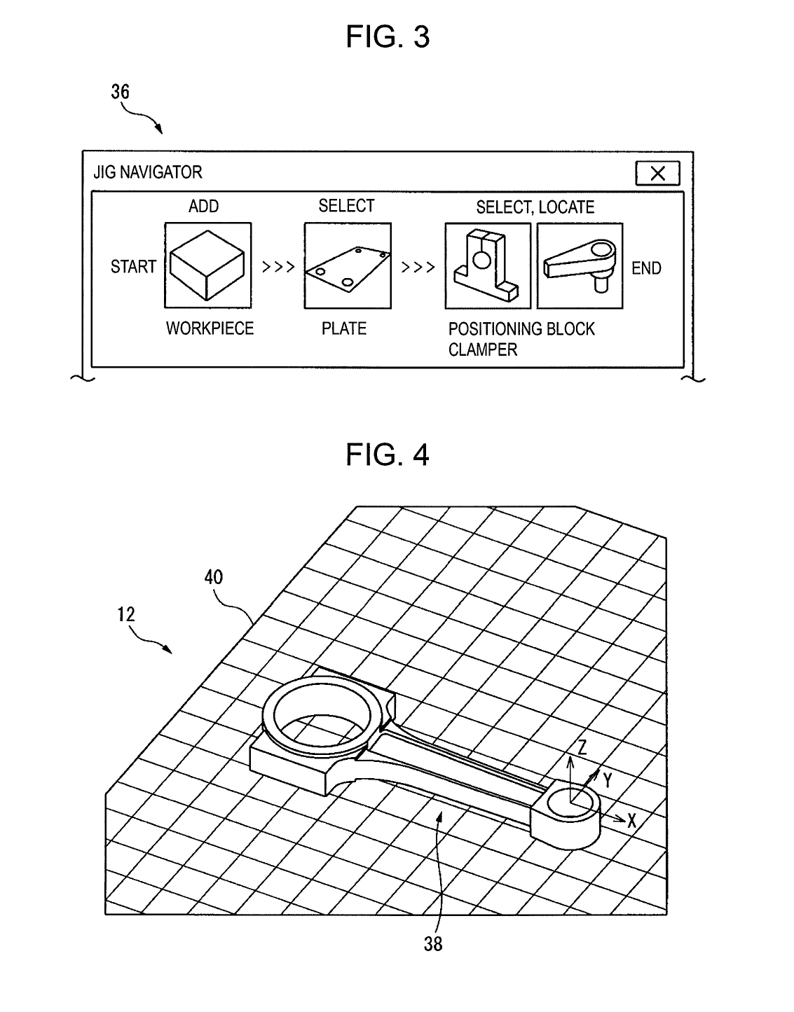

Operations of the assisting device 10 will be described hereinafter with reference to the flowchart in FIG. 2 and the like. First, a menu screen (navigator) 36 such as that illustrated as an example in FIG. 3 is displayed on the display 12, and the designer (operator) then designates the type of a workpiece by manipulating the mouse 16, etc. (step S1). Here, as one example, the workpiece is assumed to be a conrod (connecting rod) 38, such as that illustrated in FIG. 4.

Next, a three-dimensional model (CAD model data) of the designated workpiece 38 is read out from the storage section 20 (step S2). Furthermore, a three-dimensional model (data) of an attachment plate 40 suited to the size and the shape, etc., of the workpiece 38 is automatically read out from the storage section 20, and these models are located/displayed in a virtual three-dimensional space (on the display 12) in a state where the workpiece 38 is attached to the attachment plate 40, as illustrated in FIG. 4 (step S3). Although the type of the attachment plate 40 can be automatically extracted from the storage section 20 on the basis of the type of the designated workpiece 38, the operator may select/designate the type from the menu screen 36 illustrated in FIG. 3.

Next, in step S4, the operator determines, from the menu screen 36 illustrated in FIG. 4, whether the position and the dimension of the attachment plate 40 located in the three-dimensional space are appropriate. In a case where the position and the dimension are determined to be inappropriate, the operator can correct at least one of the position, shape, and dimension of the attachment plate 40 as appropriate by manipulating the mouse 16 and the keyboard 18, etc. (step S5).

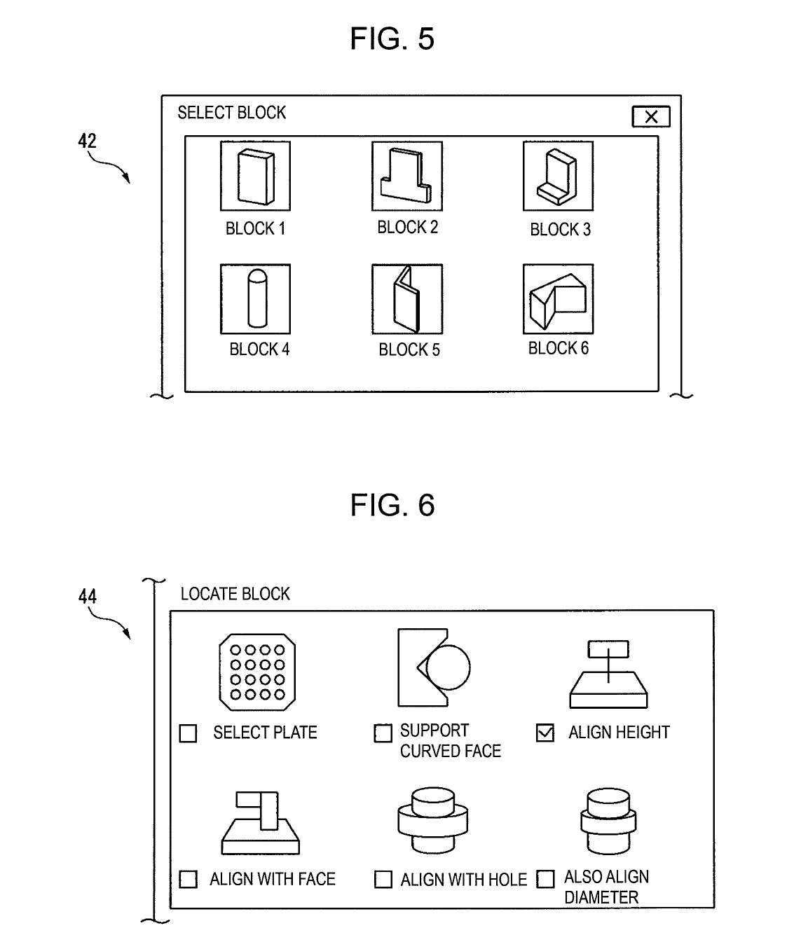

Next, in step S6, a block selection menu 42 such as that illustrated in FIG. 5 is displayed on the display 12, and the operator selects the type of a positioning block by manipulating the mouse 16, etc. Each block may have a known shape, such as a cylinder, a V-shape, an L-shape, or a T-shape, but is not limited thereto.

Next, in step S7, a block location menu 44 such as that illustrated in FIG. 6 is displayed in the display 12, and the operator selects a method for locating the positioning block by manipulating the mouse 16, etc. Here, a setting may be made such that a location method that cannot be employed with the type of the positioning block selected in step S6 cannot be selected.

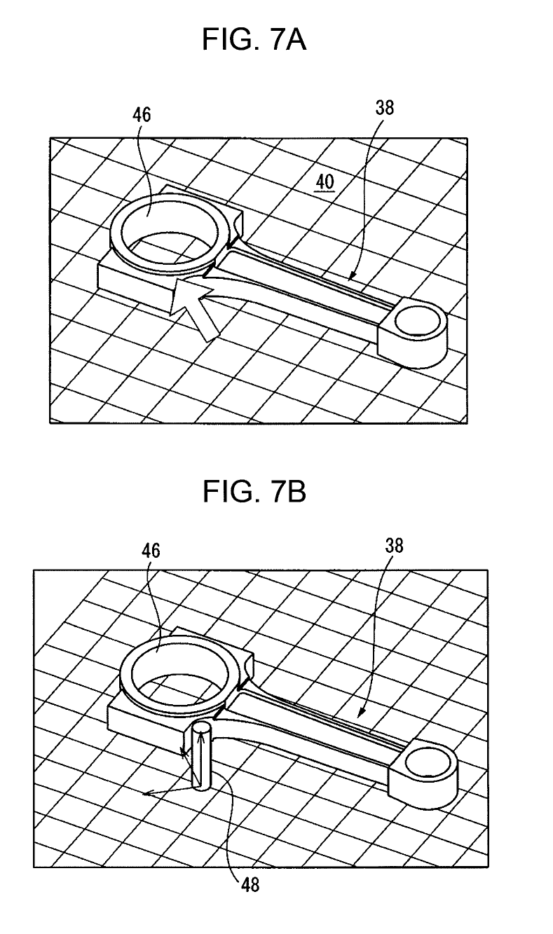

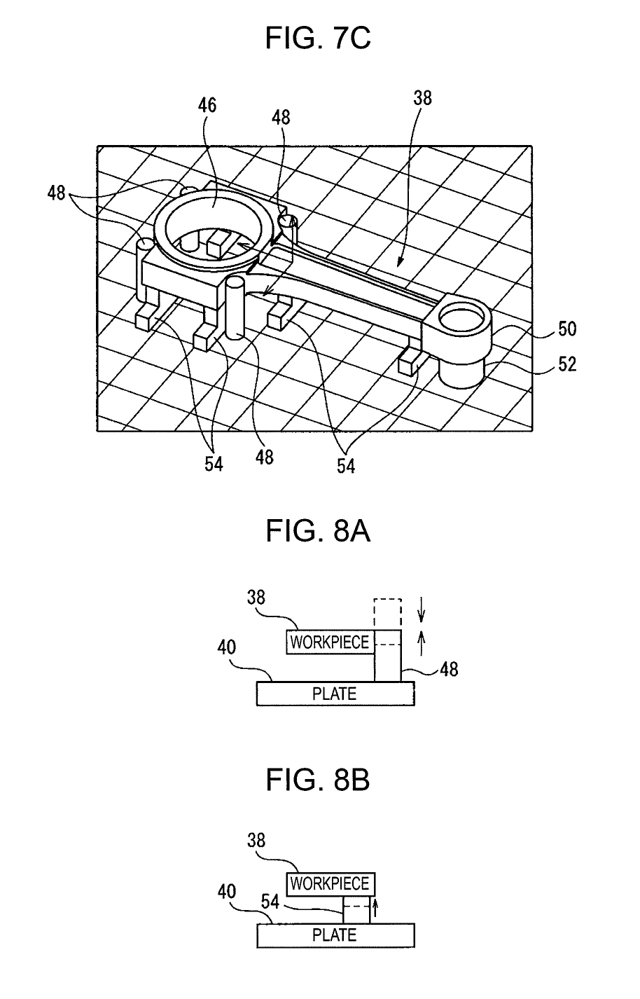

Next, in step S8, the operator designates the location position of the positioning block by manipulating the mouse 16, etc. For example, the operator designates one location on an outer surface of a large-diameter part 46 of the workpiece (conrod) 38, as indicated by the arrow in FIG. 7a. Then, as illustrated in FIG. 7b, three-dimensional model data of a pin block 48, which has been selected as the positioning block in step S6, is read out from the storage section 20 and is located/displayed so as to contact the designated location of the large-diameter part 46 (step S9).

In a case where there are a plurality of positioning blocks as illustrated in FIG. 7c, for example, the operator can designate a plurality of (four, here) locations on the outer surface of the large-diameter part 46 of the workpiece (conrod) 38, and four of the pin blocks 48 can then be located/displayed so as to contact corresponding ones of the plurality of locations designated on the large-diameter part 46. Likewise, a pin block 52 that fits with a small-diameter part 50 of the workpiece 38 is located/displayed by the operator designating an inner surface of the small-diameter part 50 of the workpiece 38. Furthermore, a plurality of T-shaped blocks 54 that support the workpiece 38 can be located by the operator designating a plurality of locations on the bottom face of the workpiece 38.

Alternatively, positioning blocks that contact a plurality of locations on the large-diameter part 46, etc., can also be automatically located, as illustrated in FIG. 7c, simply by the operator designating a single location on the workpiece, such as the large-diameter part 46. In this case, in a case where a locating rule is set in advance for the plurality of positioning blocks indicating, for example, how many of the positioning blocks (here, the pin block 48) are located at what intervals (here, intervals at equal angles of 90 degrees) for each part of the workpiece (e.g. the large-diameter part 46), the operator can designate a single part of the large-diameter part 46 and have pin blocks automatically located at a plurality of positions including that designated part on the basis of the locating rules. For the clampers (described later) too, in the case where a locating rule is set in advance for a plurality of clampers, and the operator designates one location of the workpiece to be gripped by a clamper, the clampers can be automatically located at a plurality of parts including the designated location.

FIGS. 8a and 8b are diagrams illustrating a process, carried out in step S9, for automatically adjusting the shape or dimension of the positioning block in accordance with a position on the surface of the designated workpiece. For example, in a case where, as illustrated in FIG. 8a, the operator selects “align with (workpiece) height” as the locating method of the pin block 48 (step S7) before designating the outer surface of the workpiece 38 in order to locate the pin block 48 (step S8), the height of the pin block 48 is automatically adjusted to the same height as the large-diameter part 46 of the workpiece 38.

Likewise, in a case where, for example, as illustrated in FIG. 8b, the operator selects “align with (workpiece) surface” (see FIG. 6) as the locating method of a T-shaped block 54 (step S7) before designating the bottom face of the workpiece 38 in order to locate the T-shaped block 54 (step S8), the height of the T-shaped block 54 is automatically adjusted so that a top face of the T-shaped block 54 contacts the bottom face of the workpiece 38. In this manner, at least one of the shape and dimension of the positioning block can be automatically adjusted as intended by the operator even without the operator inputting any specific numerical value, etc.

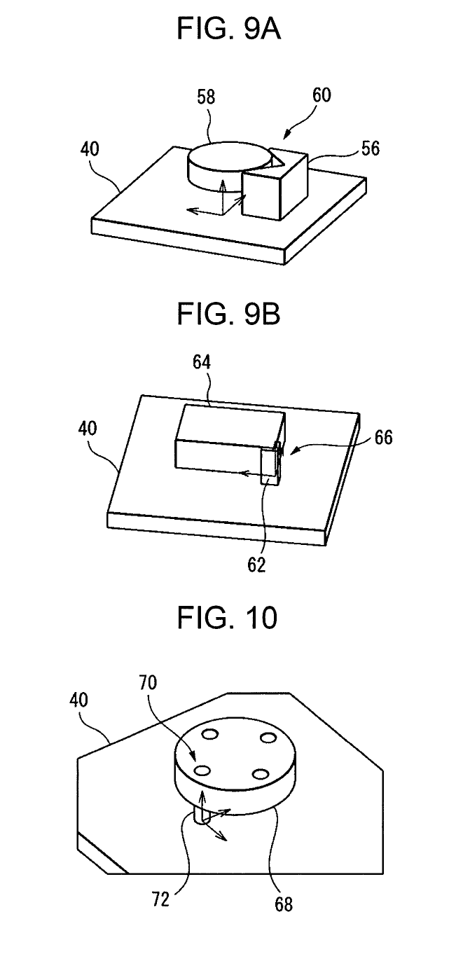

FIGS. 9a and 9b are diagrams illustrating a process, carried out in step S9, for automatically adjusting the location position of the positioning block in accordance with the position and shape of a face or edge of the designated workpiece. For example, in a case where, as illustrated in FIG. 9a, the operator selects “support curved face” as the locating method of a V-shaped block 56 (step S7) before designating the outer surface of a disk-shaped or cylindrical workpiece 58 (indicated by the arrow 60) in order to locate the V-shaped block 56 (step S8), the location position of the V-shaped block 56 is automatically adjusted to contact a curved face (the outer circumferential surface) of the workpiece 58.

Likewise, in the case where, for example, as illustrated in FIG. 9b, the operator selects “align with (workpiece) surface” (see FIG. 6) as the locating method of an L-shaped block 62 (step S7) before designating a side face of a substantially parallelepiped workpiece 64 in order to locate the L-shaped block 62 (step S8), the position of the L-shaped block 62 is automatically adjusted so that the L-shaped block 62 contacts a corner part of the workpiece 64 (indicated by the arrow 66). In this manner, the location position of the positioning block can be automatically adjusted as intended by the operator without the operator manually changing the position of the positioning block.

In the example illustrated in FIG. 9a or 9b, at least one of the shape and the dimension of the positioning block may be automatically adjusted in accordance with the shape and the dimension, etc. of the workpiece. For example, the height of the V-shaped block 56 or the L-shaped block 64 can be automatically adjusted so as to match the height of the workpiece, in the same manner as in the example illustrated in FIG. 8a.

FIG. 10 is a diagram illustrating an example of designating a face or an edge of a circular shape (a circular hole, here) and automatically adjusting the location position of the positioning block in accordance with the designated position and shape, carried out in step S9. In a case where a workpiece 68 has at least one hole 70, a pin block 72 can be inserted into the hole 70 so as to position the workpiece 68. In this regard, in a case where the operator selects “align with hole” (see FIG. 6) as the method for locating the pin block 72 (step S7) before designating the hole 70 (step S8), the pin block 72 can automatically be located in a state where the pin block 72 is inserted into the hole 70. Additionally, in a case where, in step S7, “also align diameter” is selected, the pin block 72 is located within the hole 70 having automatically adjusted (increased or reduced) the outer diameter of the pin block 72 to be equal to the inner diameter of the hole 70.

Next, in step S10, the operator determines whether the position and size of the located positioning block are appropriate, on the basis of display screens such as those illustrated in FIGS. 7a to 10. In a case where the position and size are determined to be inappropriate, the operator changes the position and/or the size of the positioning block by manipulating the mouse 16 and the keyboard 18, etc. (step S11). Note that in the case where there are a plurality of positioning blocks, the processes from steps S6 to S11 can be repeated the same number of times as there are positioning blocks (step S12).

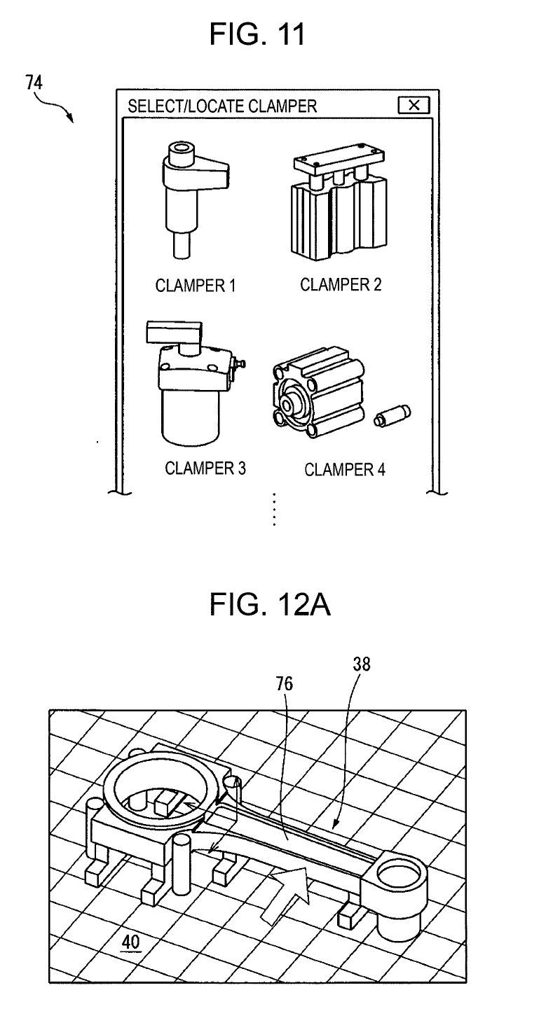

Next, in step S13, a clamper selection menu 74 such as that illustrated in FIG. 11 is displayed on the display 12, and the operator selects the type of a clamper by manipulating the mouse 16, etc. Although a hook-type clamper (a clamper 1), a guide-equipped cylinder (a clamper 2), a swinging clamper (a clamper 3), and a cylinder (a clamper 4) can be given as types of clampers, the types are not limited thereto.

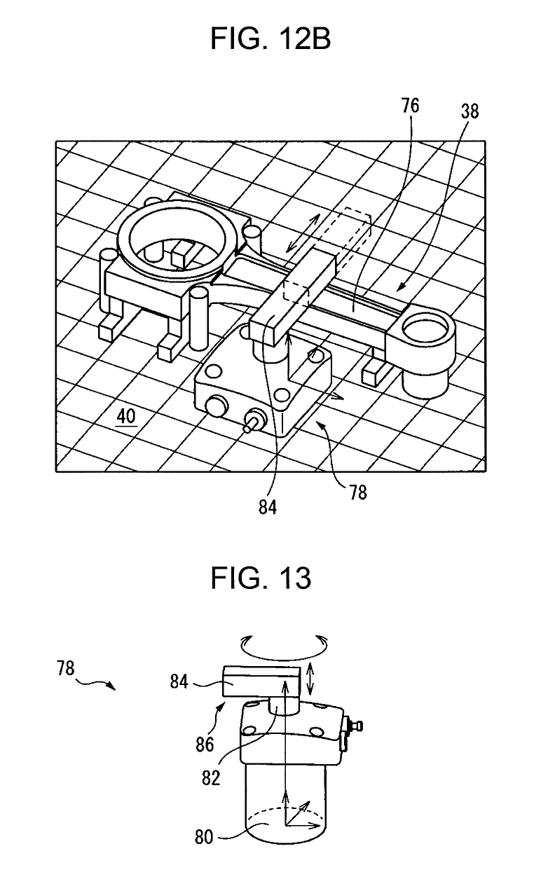

Next, in step S14, the operator designates the location position of the selected clamper by manipulating the mouse 16, etc. For example, by the operator designating a gripped part (a rod part) 76 of the workpiece 38 as illustrated in FIG. 12a, a three-dimensional model of a clamper (here, a swinging clamper) 78 read out from the storage section 20 is automatically located/displayed so as to grip the rod part 76, as illustrated in FIG. 12b (step S15).

In step S14, the operator may make definitions (configurations) pertaining to the movement of a mobile part of the clamper, through the input section 14, etc. For example, the swinging clamper 78 illustrated in FIG. 12b includes a main body 80, a shaft 82 capable of extending/retracting and rotating relative to the main body 80, and a mobile part (a claw) 84 attached to a tip of the shaft 82, as illustrated in FIG. 13. In this case, the operator can define/configure an axis of rotation and a rotation angle, as well as an extension/retraction amount, for the shaft 82, and furthermore can define/configure a position 86 at which the claw 84 makes contact with (the rod part 76 of) the workpiece 38 (a bottom face of the claw 84, in the example illustrated here), by manipulating the input section 14 (the mouse 16 and the keyboard 18, etc.). By doing so, the dimensions, shape, and the like of the clamper 78 can be automatically adjusted (e.g., changing the length of the claw 84) so that the position of contact 86 between the rod part 76 and the claw 84 match, as illustrated in FIG. 12b.

Next, in step S16, the operator determines whether the position and size of the located clamper are appropriate, on the basis of display screen such as that illustrated in FIG. 12b. In the case where the position and size are determined to be inappropriate, the operator changes the position and the size, etc., of the positioning block by manipulating the mouse 16 and the keyboard 18, etc. (step S17). Note that in the case where there are a plurality of clampers, the processes from steps S13 to S17 can be repeated the same number of times as there are clampers (step S12).

With the assisting device according to the present embodiment, one or both of the dimension and shape of a jig can, in addition to the location position of the jig, be automatically adjusted on the basis of the shape of a designated workpiece, the method for locating the jig, etc. As such, even a comparatively inexperienced operator can appropriately understand in what position a jig (a positioning block and the clamper) of a given size is to be located. As such, the assisting device makes it possible to create a jig model that, while rough, is sufficient for understanding the overall structure of the jig, and is thus particularly effective when used before the detailed design of the jig is created.

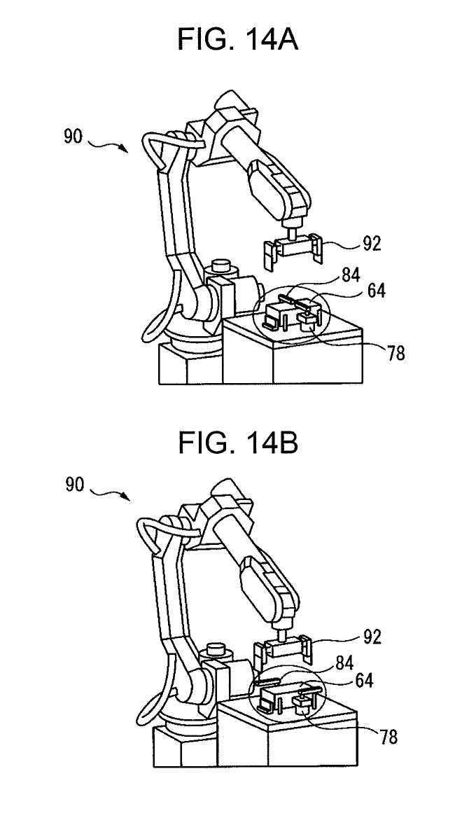

FIGS. 14a and 14b are diagrams illustrating an example of application in a robot simulation device (a robot simulator) 88 (schematically illustrated in FIG. 1), in which a three-dimensional model of the jig designed or created using the assisting device 10 is located within a virtual space in which a virtual three-dimensional model of a robot is located, that simulates operations of the robot. In this example, a simulation in which an opening/closing operation of a clamper and an operation of handling a workpiece by the robot are executed in tandem is carried out. To be more specific, an operation in which the parallelepiped workpiece 64 illustrated in FIG. 9b is gripped by using two of the swinging clampers 78 illustrated in FIG. 13, i.e. a “clamper closed” state (FIG. 14a), and operation of pivoting the claws 84 of the clampers 78 from the state illustrated in FIG. 14a, i.e. a “clamper open” state (FIG. 14b), and an operation of a robot hand 92 of a robot 90 displayed virtually grips and removes the workpiece 64 from the state illustrated in FIG. 14b (not illustrated), can be simulated.

In a case where the opening/closing operation of the clamper and the handling operation of the robot are carried out in tandem, it is necessary to design a jig so as not to interfere with the robot, taking into account the shape of the robot hand, the position at which the hand grips the workpiece, the opening/closing operation of the hand, and furthermore the opening/closing operation of the clamper. This has been a considerable burden even for an experienced operator. However, using a simulator such as that described above makes it easy to check for interference, which in turn makes it easy to design the jig.

Like the assisting device 10, the robot simulator 88 can be provided as a device including an arithmetic processing device (a processor) and a storage device (memory), e.g. a personal computer, and can display a virtual three-dimensional space such as that illustrated in FIGS. 14a and 14b in a screen. Additionally, the robot simulator 88 is configured to be capable of communicating with the assisting device 10, and can therefore accept data pertaining to the shape of the jig created by the assisting device 10, and operations, etc., as signals or the like and use that data to simulate the operations of a robot as described above. Alternatively, the functions of the assisting device 10 (the processor and the memory, etc.) can be incorporated into the robot simulator as well.

According to the present disclosure, components constituting a jig can be located within a virtual space through a simple operation, and the shape and the dimensions, etc., of the jig can be automatically adjusted as necessary, before the jig is designed in detail.

While the invention has been described with reference to specific embodiments chosen for the purpose of illustration, it should be apparent that numerous modifications could be made thereto, by one skilled in the art, without departing from the basic concept and scope of the invention.

1. A jig design assisting device configured to assist designing of a jig, the jig including a positioning block and a clamper, and the jig anchoring a workpiece, the device comprising:
a display section configured to display a virtual three-dimensional space on a screen;
a storage section configured to store three-dimensional models of the workpiece, the positioning block, the clamper, and an attachment plate to which the workpiece can be attached;
a workpiece designating section configured to designate a type of the workpiece anchored by the jig;
a workpiece locating section configured to read out the three-dimensional model of the workpiece designated by the workpiece designating section from the storage section, read out the three-dimensional model of the attachment plate to which the designated workpiece can be attached from the storage section, and automatically locate the designated workpiece within the three-dimensional space in a state in which the workpiece is attached to the read-out attachment plate;
a positioning block selecting section configured to select a type and a location method of the positioning block;
a clamper selecting section configured to select a type of the clamper;
a model part designating section configured to designate a model part, in the three-dimensional model of the designated workpiece, that contacts the positioning block or the clamper;
a jig locating section configured to read out the three-dimensional model of the positioning block or the clamper from the storage section and locate the read-out three-dimensional model in the three-dimensional space, based on the designated model part and the content of the selection made by the positioning block selecting section or the clamper selecting section; and
an adjusting section configured to automatically adjust a dimension or a shape of the three-dimensional model of the positioning block or the clamper located by the jig locating section, in accordance with a dimension or a shape of the designated workpiece.

2. The jig design assisting device of claim 1,
wherein when one part of a model part contacting the positioning block or the clamper has been designated, based on a predetermined location rule for a plurality of positioning blocks or clampers, the jig locating section is configured to automatically locate pin blocks or clampers at a plurality of parts including the one designated part on the basis of the location rule.

3. The jig design assisting device of claim 1, further comprising:
an input section capable of inputting settings pertaining to movement of a mobile part of the clamper and a contact position of the mobile part that contacts the workpiece,
wherein the adjusting section automatically adjusts a dimension of the mobile part, based on a dimension or a shape of the designated workpiece and the inputted contact position.

4. A robot simulation device configured to locate a three-dimensional model of a jig, the jig being designed or created by the jig design assisting device of claim 1, in a virtual space in which a virtual three-dimensional model of a robot is located, and simulate an operation of the robot.
